(19) United States
(12) Patent Application Publication
(10) Pub. No.: US 2026/0221543 A1
(43) Pub. Date: Jul. 30, 2026

(54) HALTING OPERATION OF AN ALUMINUM-AIR BATTERY USING MIXTURES OF WATER AND POLYOLS

(71) Applicant: PHINERGY LTD, Kfar Saba (IL)

(72) Inventor: Ilya YAKUPOV, Rehovot (IL)

(73) Assignee: PHINERGY LTD, Kfar Saba (IL)

(21) Appl. No.: 19/146,931

(22) PCT Filed: Jan. 26, 2024
(86) PCT No.: PCT/IL2024/050111

§ 371 Date: Jul. 10, 2025

Related U.S. Application Data
(60) Provisional application No. 63/441,191, filed on Jan. 26, 2023.

(51) Int. Cl. H01M 12/06; H01M 4/46; H01M 10/24; H01M 50/609; H01M 50/691; H01M 50/70

(52) U.S. Cl. CPC H01M 12/06; H01M 4/463; H01M 10/24; H01M 50/609; H01M 50/691; H01M 50/70

(57) ABSTRACT

Systems and methods of operating aluminum-air electrochemical cells are provided, in which, following operation of the electrochemical cell(s), the alkaline electrolyte is removed from the cell(s) and a mixture of water with oxygen-rich organic solvent(s) is introduced to protect the aluminum anodes from corrosion by the electrolyte residues. For example, the cell(s) may be flooded with the mixture and then drained, or the mixture may be circulated through the cell(s). During stand-by, the mixture may be used to flood or to be circulated through the cell(s) and drained, to further enhance the operability of cell(s) during operation.

### BACKGROUND OF THE INVENTION

### 1. Technical Field

The present invention relates to the field of aluminum-air batteries, and more particularly, to protecting the batteries after halting and during stand-by.

### 2. Discussion of Related Art

Halting the operation of an aluminum-air battery and removing the alkaline electrolyte therefrom result in processes at the anodes and at the cathodes which cause degradation of the future operation of the aluminum-air battery. For example, at the anode side, residual alkalinity causes release of hydrogen as well as development of aluminum oxides that reduce the future activity of the anode. On the cathode side, residual electrolyte causes the formation of carbonates from available CO₂, which reduce the hydrophobicity of the cathode and cause formation of structures that in following operation of the aluminum-air battery allow water to flood through the air cathode, reducing its efficiency and degrading the battery. These effects are depicted schematically in FIG. 1, with aluminum-air cells 90 illustrated schematically during operation (state 90A), upon halting of operation (after removal of the electrolyte, state 90B) and during standby (state 90C). Aluminum-air cells 90 include aluminum anodes 92, air cathodes 94 and electrolyte 96 during operation.

U.S. Pat. No. 9,627,726, incorporated herein by reference in its entirety, teaches shutdown systems and methods for battery shutdown followed by a standby mode using a washing solution controlled by pH such that the electrode remains stable. U.S. Pat. No. 10,532,384, incorporated herein by reference in its entirety, teaches systems and methods for treating electrodes used in batteries and electrochemical cells upon battery/cell shutdown and prior to battery standby mode—by using an aerosol to treat the electrode and to protect the electrode and/or the environment from undesired reactions.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides a method of operating an aluminum-air electrochemical cell, the method comprising, following operation of the electrochemical cell, removing alkaline electrolyte therefrom and introducing a mixture of water with oxygen-rich organic solvent(s) to create a layer upon the surface of aluminum anodes of the cell, which hinders aluminum corrosion reactions with alkaline electrolyte residues, and thus preserves the aluminum anodes during battery standby, and/or reduce corrosion reactions of the anode aluminum with electrolyte residues.

One aspect of the present invention provides a system comprising aluminum-air cells and a washing unit configured to replace, upon halting the operation of the aluminum-air cells, alkaline electrolyte in the cells with a mixture of water with oxygen-rich organic solvent(s) to create a layer upon the surface of aluminum anodes of the cell, which hinders aluminum corrosion reactions with alkaline electrolyte residues, and thus preserves the aluminum anodes during battery standby, and/or reduce corrosion reactions of the anode aluminum with electrolyte residues.

These, additional, and/or other aspects and/or advantages of the present invention are set forth in the detailed description which follows, possibly inferable from the detailed description, and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout. In the accompanying drawings:

FIG. 1 is a high-level schematic illustration of prior art aluminum-air cells during operation, after halting and during stand-by, with indications for some of the reactions taking place in them, according to the prior art.

FIG. 2 is a high-level schematic illustration of disclosed aluminum-air cells during operation, after halting and during stand-by, with indications for some of the reactions taking place in them as well as prevented unwanted reactions and maintenance during stand-by, according to some embodiments of the invention.

FIG. 3 is a high-level schematic illustration of a system comprising aluminum-air cells and a washing unit, according to some embodiments of the invention. The system, a controller thereof and/or the washing unit are configured to replace, upon halting the operation of the aluminum-air cells, alkaline electrolyte in the cells with a mixture of water with oxygen-rich organic solvent(s) to reduce corrosion of the aluminum anodes during standby.

FIG. 4 is a high-level schematic flowchart illustrating a method of operating aluminum-air electrochemical cell(s), according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Some embodiments of the present invention provide efficient and economical methods and mechanisms for halting operation and protection of aluminum-air batteries using mixtures of water and polyols and thereby provide improvements to the technological field of managing assemblies of aluminum-air batteries.

Systems and methods of operating aluminum-air electrochemical cells are provided, in which, following operation of the electrochemical cell(s), the alkaline electrolyte is removed from the cell(s) and a mixture of water with oxygen-rich organic solvent(s) is introduced to create a layer on the surface of the aluminum anodes of the cell, protecting them from corrosion reaction with residues of alkaline electrolyte. For example, the cell(s) may be flooded with the mixture and then drained, or the mixture may be circulated through the cell(s). During stand-by, the mixture may be used to flood or to be circulated through the cell(s) and drained, to further enhance the operability of cell(s) during operation. Washing the cells after operation and/or during stand-by removes electrolyte residues and/or prevent unwanted reactions of anode and/or cathode materials.

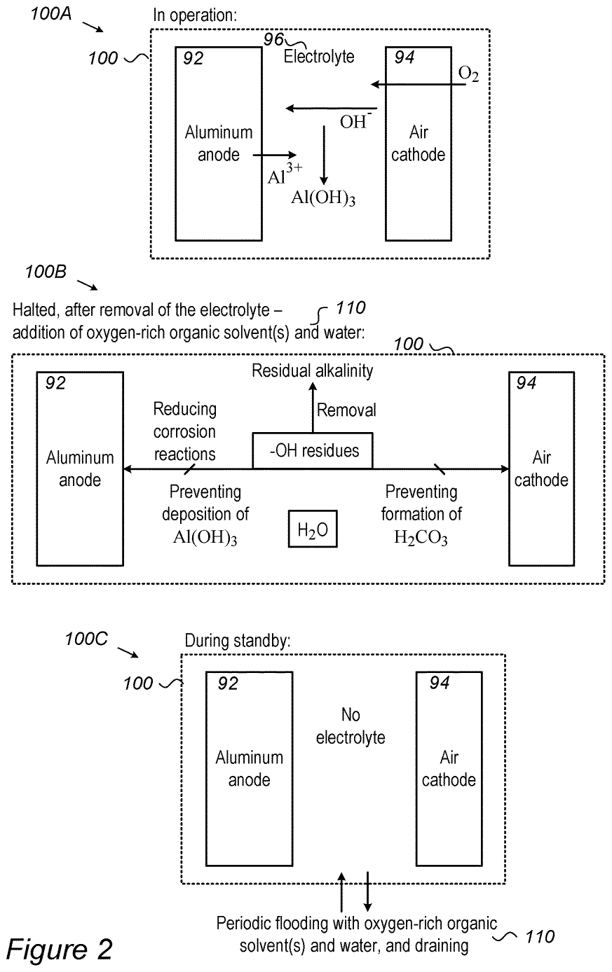

FIG. 2 is a high-level schematic illustration of disclosed aluminum-air cells 100 during operation (100A), after halting (100B) and during stand-by (100C), with indications for some of the reactions taking place in them as well as prevented unwanted reactions and maintenance during stand-by, according to some embodiments of the invention.

Following research, the inventor has found out that using mixtures of water and polyols (denoted schematically by numeral 110) for washing the electrodes (anode(s) 92 and/or cathode(s) 94) may effectively remove the residual alkalinity-preventing electrode deterioration, and may also be used to protect the electrodes (anode(s) 92 and/or cathode(s) 94) during periods the battery is not operated. Removing alkaline electrolyte from the electrochemical cell halts cell activity and/or reduces electrolyte activity within the cell.

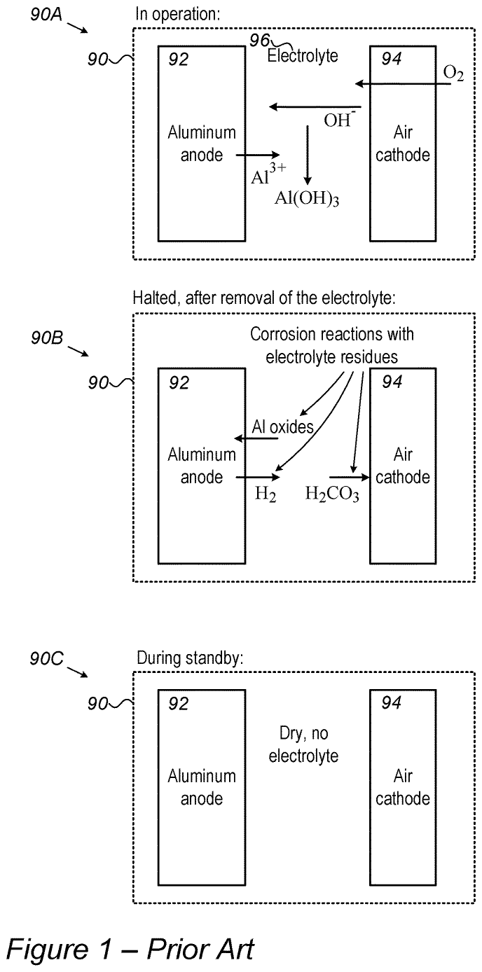

A mixture of water with oxygen-rich organic solvent(s) such as polyols may be used to (i) remove the residual alkalinity to reduce electrolyte activity within the cell, (ii) stabilize the remaining Al(OH)₃ so as to prevent its deposition on the anodes and maintain the performance of the anodes during inoperative periods, (iii) prevent formation of carbonates on the cathode, and (iv) maintain the cathode's hydrophobicity while also preventing drying of the cathode. The mixture of polyols with water further reduces the surface tension of the water and therefore helps keep the cathode wet and prevent drying of the battery cells. These processes are illustrated schematically in FIG. 2 (and in comparison to the parallel stages of operation and stand-by in priori art batteries illustrated in FIG. 1).

Examples for such mixtures include a mixture of water and glycerol (e.g., at a 1:1 ratio or any ratio between 1:3 and 3:1 or between 1:9 and 9:1, e.g., in volume) and mixtures of water with any of: ethylene glycol, di-, tri- or poly-ethylene glycol, poly vinyl alcohols, polyethylene oxide and polyacrylic acid. For example, glycerol has high viscosity, which leaves a layer on anode(s) 92 and/or cathode(s) 94 that, e.g., protects anode(s) 92 from forming an oxide layer that reduces the activity of the anodes, and also has high surface tension that, e.g., does not flood air cathode(s) 94.

Disclosed mixtures, such as glycerol-water mixtures, absorb residual electrolyte that may remain in the cell, and thus prevent the continuation of detrimental electrochemical reactions.

Advantageously, disclosed embodiments do not neutralize basic electrolyte remains with an acid that is being gradually consumed, and therefore also does not form precipitates with the electrolyte residues (e.g., solid deposits such as compounds of K and Al(OH)₃ that form gradually over time)—which require removal. In contrast, disclosed mixtures are not, or hardly consumed during the process, and form little or no precipitates—both simplifying significantly the maintenance of disclosed systems, and allow circulation of the mixture intermittently or periodically over a long duration. Even though polyols are slightly acidic, in water solutions they do not shift the pH to any considerable extent and do not neutralize the electrolyte residues to any significant extent, and hence do not react in the disclosed embodiments like acids react to neutralize the basic electrolyte remains in the prior art. In contrast, in disclosed embodiments the electrolyte remains are washed by the polyol-water solution and increase its pH to a basic level, in which the polyol-water solution is further used within the cell for further washing or periodical maintenance. The inventor has found out that with repetitive use of the same washing solution it becomes more and more basic, and it still continues working effectively as “stopping solution”-which protects the cell component after draining of the electrolyte. Without being bound by theory, the inventor suggests that opposite to the prior art use of an acidic solution after halting operation of the aluminum-air cell and draining the electrolyte-currently disclosed embodiments are not based on the chemical reaction of acid-base neutralization, but possibly instead may be based on coating of battery electrodes by layer of thick, viscous chemically inert liquid. On the aluminum anode side, the polyol layer on the aluminum surface may prevent the undesired corrosion reaction of Al anode with residue of alkaline electrolyte. On the air cathode side, the polyol solution may prevent the drying out of the catalytic layer (and electrode degradation processes that may develop as a result of it), while the high surface tension makes disclosed polyol solutions safe regarding possible wetting/flooding of hydrophobic pores of the air-breathing electrode (cathode).

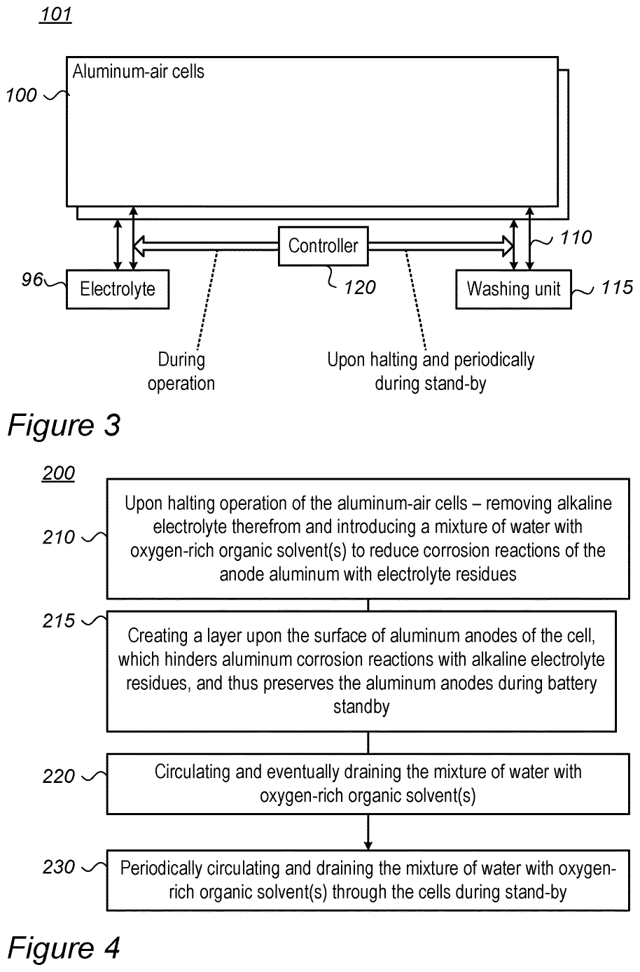

FIG. 3 is a high-level schematic illustration of a system 101 comprising aluminum-air cells 100 and a washing unit 115, according to some embodiments of the invention. System 101, a controller 120 thereof and/or washing unit 115 may be configured to replace, upon halting the operation of aluminum-air cells 100, the alkaline electrolyte in the cells and/or residues thereof—with mixture 110 of water with oxygen-rich organic solvent(s) to reduce corrosion of the aluminum anodes during standby.

System 101, controller 120 thereof and/or washing unit 115 may be further configured to circulate and eventually drain mixture 110 from cells 100.

System 101, controller 120 thereof and/or washing unit 115 may be further configured to circulate and drain mixture 110 from cells 100—periodically during stand-by.

Controller 120 may be configured to manage delivery of electrolyte 96 to and from aluminum-air cells 100 during operation (100A), and to manage delivery, draining and circulating of mixture 110 of water with oxygen-rich organic solvent(s) to and from aluminum-air cells 100 after halting operations (100B) and during stand-by (100C).

The mixture of water with oxygen-rich organic solvent(s) 110 may comprise water and at least one of: glycerol, ethylene glycol, di-, tri- and/or poly-ethylene glycol, poly vinyl alcohols, polyethylene oxide and/or polyacrylic acid.

FIG. 4 is a high-level schematic flowchart illustrating a method 200 of operating aluminum-air electrochemical cell(s), according to some embodiments of the invention. The method stages may be carried out with respect to system 101 described above, which may optionally be configured to implement method 200. The method may be at least partially implemented by at least one computer processor, e.g., in the controller. Certain embodiments comprise computer program products comprising a computer readable storage medium having computer readable program embodied therewith and configured to carry out the relevant stages of the method. The method may comprise the following stages, irrespective of their order. Elements from FIGS. 2-4 may be combined in any operable combination, and the illustration of certain elements in certain figures and not in others merely serves an explanatory purpose and is non-limiting.

Method 200 may comprise, following operation of the electrochemical cell(s), removing alkaline electrolyte therefrom and introducing a mixture of water with oxygen-rich organic solvent(s) to reduce corrosion reactions of the anode aluminum with electrolyte residues (stage 210). The mixture of water with oxygen-rich organic solvent(s) may create a layer upon the surface of aluminum anodes of the cell, which hinders aluminum corrosion reactions with alkaline electrolyte residues, and thus preserves the aluminum anodes during battery standby (stage 215). In some embodiments, the method may further comprise circulating and eventually draining the mixture from the cell (stage 220). In some embodiments, the method may further comprise circulating and draining the mixture from the cell-periodically during stand-by (stage 230). The mixture of water with oxygen-rich organic solvent(s) comprises water and at least one of: glycerol, ethylene glycol, di-, tri- and/or poly-ethylene glycol, poly vinyl alcohols, polyethylene oxide and/or polyacrylic acid.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of operating an aluminum-air electrochemical cell, the method comprising, following operation of the electrochemical cell, removing alkaline electrolyte therefrom and introducing a mixture of water with oxygen-rich organic solvent(s) to create a layer upon the surface of aluminum anodes of the cell, which hinders aluminum corrosion reactions with alkaline electrolyte residues, and thus preserves the aluminum anodes during battery standby.

2. The method of claim 1, wherein removing alkaline electrolyte from the electrochemical cell halts cell activity and/or reduces electrolyte activity within the cell.

3. The method of claim 1, further comprising circulating and eventually draining the mixture from the cell.

4. The method of claim 1, further comprising circulating and draining the mixture from the cell-periodically during stand-by.

5. The method of claim 1, wherein the mixture of water with oxygen-rich organic solvent(s) comprises water and at least one of: glycerol, ethylene glycol, di-, tri- and/or poly-ethylene glycol, poly vinyl alcohols, polyethylene oxide and/or polyacrylic acid.

6. The method of claim 5, wherein the mixture of water with oxygen-rich organic solvent(s) comprises between 1:9 and 9:1 water and glycerol.

7. A system comprising aluminum-air cells and a washing unit configured to replace, upon halting the operation of the aluminum-air cells, alkaline electrolyte in the cells with a mixture of water with oxygen-rich organic solvent(s) to create a layer upon the surface of aluminum anodes of the cell, which hinders aluminum corrosion reactions with alkaline electrolyte residues, and thus preserves the aluminum anodes during battery standby, and/or reduce corrosion reactions of the anode aluminum with electrolyte residues.

8. The system of claim 7, wherein replacing the electrolyte with the mixture halts cell activity, and removing residual alkalinity reduces electrolyte activity within the cell.

9. The system of claim 7, further configured to circulate and eventually drain the mixture from the cells.

10. The system of claim 7, further configured to circulate and drain the mixture from the cells-periodically during stand-by.

11. The system of claim 7, wherein the mixture of water with oxygen-rich organic solvent(s) comprises water and at least one of: glycerol, ethylene glycol, di-, tri- and/or poly-ethylene glycol, poly vinyl alcohols, polyethylene oxide and/or polyacrylic acid.

12. The system of claim 11, wherein the mixture of water with oxygen-rich organic solvent(s) comprises between 1:9 and 9:1 water and glycerol.

13. The system of claim 7, further comprising a controller configured to manage delivery of electrolyte to and from the aluminum-air cells during operation, and to manage delivery, draining and circulating of the mixture of water with oxygen-rich organic solvent(s) to and from the aluminum-air cells after halting operations and during stand-by.
